(19) United States
(12) Patent Application Publication
(10) Pub. No.: US 2011/0145264 A1
(43) Pub. Date: Jun. 16, 2011

(54) METHOD AND APPARATUS FOR AUTOMATICALLY CREATING ALLOMORPHS

(75) Inventors: YiGyu HWANG, Daejeon (KR); Jeong HEO, Daejeon (KR); Chung Hee LEE, Daejeon (KR); HYO-JUNG OH, Daejeon (KR); Soojong LIM, Daejeon (KR); HyunKi KIM, Daejeon (KR); Miran CHOI, Daejeon (KR); Pum Mo RYU, Daejeon (KR); Yeo Chan YOON, Daejeon (KR); Changki LEE, Daejeon (KR); Myung Gil JANG, Daejeon (KR)

(73) Assignee: Electronics and Telecommunications Research Institute, Daejeon (KR)

(21) Appl. No.: 12/816,008

(22) Filed: Jun. 15, 2010

(30) Foreign Application Priority Data
Dec. 14, 2009 (KR) 10-2009-0123772

(51) Int. Cl. G06F 17/30

(52) U.S. Cl. 707/754; 707/E17.044

(57) ABSTRACT

A method of automatically creating allomorphs of a keyword, includes creating allomorph candidates of a search keyword using a user log and/or user session information when the search keyword is input; and extracting a related word for verification from a web document using a related word patter from to verify the allomorph candidates. Further, the method of automatically creating allomorphs of a keyword includes removing over-created and/or erroneous candidates from the allomorph candidates using the extracted related word for verification and creating allomorphs of the search keyword.

### CROSS-REFERENCE TO RELATED APPLICATIONS

The present invention claims priority of Korean Patent Application No. 10-2009-0123772, filed on Dec. 14, 2009, which is incorporated herein by reference.

### FIELD OF THE INVENTION

The present invention relates to a method of and an apparatus for automatically creating allomorphs; and, more particularly to a method of and an apparatus for removing over-created and/or erroneous candidates of allomorphs (synonyms) of from allomorph candidates created by using user log or user session information with respect search keywords and creating allomorphs of the search keyword.

### BACKGROUND OF THE INVENTION

In general, a vocabulary may have several allomorphs with same meaning. In the earlier search system such as a literature search, a user does not seriously consider mismatch between the search keyword and vocabularies included in literatures to be searched for because of performing the search with controlled vocabularies.

In a case where related words or synonyms of a specific keyword are manually prepared in advance in the search system, the word mismatch between the keyword and the literatures to be searched for does not affect seriously. However, both of the above-mentioned methods are so manually carried out that cannot be applied to a system for searching a great deal of web documents.

When a user inputs a keyword to search for “Ezochi Snow Festival”, the user cannot search for web documents expressed by “Hokkaido Snow Festival,” “Hokaido Snow Festival,” and “ [symbol] [symbol] Snow Festival.” Moreover, an input of “Hyundai Motor Manufacturing Alabama” cannot provide search results of information expressed by “Hyundai Motor Manufacturing Allabama.” “Bookaedo (Korean Transliteration of Hokkaido) may be expressed in various words such as “Hokkaido,” “Hokaido,” “ [symbol] (Chinese form of Hokkaido),” and “Ezochi” and “Alabama (Korean transliteration of Alabama)” has a lot of allomorphs with same meaning such as “Allabama,” and “Alabama.”

An existing search engine, in order to process various allomorphs having same meaning) uses a manual creation of allomorphs, a semi-automatic creating method using patterns extracting related words with a language analyzer, or language resource such as Wordnet. However, these methods are expensive and cannot create all allomorphs in Web documents.

### SUMMARY OF THE INVENTION

In view of the above, the present invention provides a method of automatically creating allomorphs of a keyword based on statistical information and morphological similarity between keywords using a great deal of keyword log and click log.

In the method of automatically creating allomorphs of the present invention, when a search keyword can be subdivided into at least one meaningful keyword, an unshared keyword is considered as an allomorph candidate and allomorphs are selected by an allomorph recognizing method.

Moreover, in the method of the present invention, when change of an input in a single user session within a preset range is detected using user session information from a user search log, the change is selected as an allomorph candidate.

In accordance with a first aspect of the present invention, there is provided a method of automatically creating allomorphs of a keyword, including: creating allomorph candidates of a search keyword using a user log and/or user session information when the search keyword is input; extracting a related word for verification from a web document using a related word patter from to verify the allomorph candidates; and removing over-created and/or erroneous candidates from the allomorph candidates using the extracted related word for verification and creating allomorphs of the search keyword.

In accordance with a second aspect of the present invention, there is provided an apparatus for automatically creating a keyword allomorphs, including: an allomorph candidate creation unit creating allomorph candidates of a search keyword using a keyword log and/or user session information when the search keyword is input; a related word-for-verification extracting unit extracting a related word for verification using a related word pattern from a web document for verification of the allomorph candidates; and an allomorph creation unit remove over-created and/or erroneous candidates from the allomorph candidates using the extracted related word for verification and creating allomorphs of the search keyword.

In accordance with the allomorph automatic creating method and apparatus of the present invention, allomorphs of a search keyword are automatically created, so that search results for an input keyword of a user using the allomorphs may be expanded and quality of the search results may be improved.

Moreover, in order to overcome the mismatch between indices and search keyword, which is frequently generated in a search system, recommendation for a query or automatic query expansion may be utilized so that satisfaction for the search results can be enhanced.

### BRIEF DESCRIPTION OF THE DRAWINGS

The objects and features of the present invention will become apparent from the following description of embodiments given in conjunction with the accompanying drawings, in which:

FIG. 1 is a block diagram illustrating an apparatus for automatically creating allomorphs of a keyword in accordance with an embodiment of the present invention;

FIG. 2 is a detailed block diagram illustrating an allomorph creation unit of the allomorph-of-keyword automatic creation apparatus; and

FIG. 3 is a flow chart illustrating the apparatus for automatically keyword allomorphs in accordance with the embodiment of the present invention.

### DETAILED DESCRIPTION OF THE EMBODIMENTS

Hereinafter, embodiments of the present invention will be described in detail with reference to the accompanying drawings which form a part hereof.

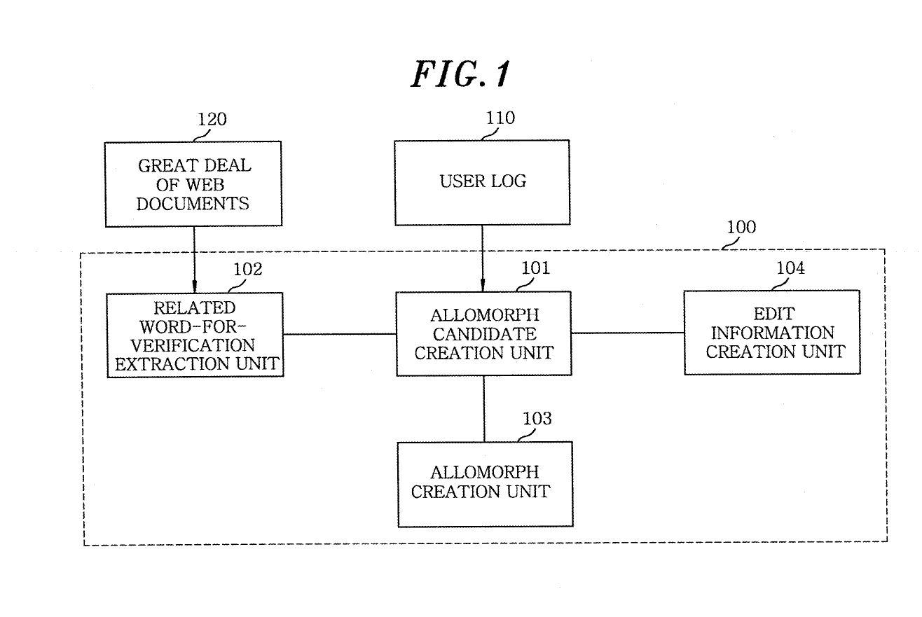

FIG. 1 is a block diagram illustrating an apparatus for automatically creating allomorphs of a keyword according to an embodiment of the present invention. Referring to FIG. 1, the allomorph-of-keyword automatic creation apparatus includes an allomorph candidate creation unit 101, a related word-for-verification extraction unit 102, and an allomorph creation unit 103.

The allomorph creation unit 103, when a search keyword is input, creates allomorphs of the search keyword using a keyword log 110 for the search keyword or user session information.

The user log 110 includes a triple of {“keyword,” user_IP, and click_URL}. In the embodiment of the present invention, a keyword is separated into at least one meaningful unit. The separated unit is called a “token.” For example, “Beijing University” includes two tokens of “Beijing” and “University.” A token is combined with another token to create a new token. A keyword “Hyundai Motor Manufacturing Alabama” includes six tokens such as “Hyundai,” “Motor,” “Manufacturing,” and “Alabama.” Erroneous word spacing makes creation of a token impossible. An object allomorphs of which are created in this stage is a user input keyword including one or more tokens.

The allomorph candidate creation unit 101 extracts logs having at least one token from the user log 110 and groups logs sharing a single token from the extracted logs to create allomorph candidates.

In more detail, the allomorph candidate creation unit 101 extracts logs having at least token to creates candidate logs, groups logs sharing a single token from the candidate logs, and creates the allomorph candidates from the grouped logs. For example, “Ttokyo University (Korean transliteration of Tokyo University),” “Tokyo University,” “ [symbol] (Chinese Characters of Tokyo University),” and “Osaka University” share a token “University” and the terms “Ttokyo,” “Tokyo,” “ [symbol] (Korean transliteration of Tokyo),” and “Osaka” are allomorph candidates included in a same group.

The related word-for-verification extraction unit 102 extracts related words for verification from the web documents 120 using patterns of related words in order to verify the allomorph candidates.

When there are patterns for creating the allomorph candidates from a great deal of web documents 120, the patterns are used as knowledge for verifying the allomorph candidates. The following lists are various allomorphs frequently found in web documents.

“Bookaedo (Korean transliteration of Hokkaido) is the northernmost island of Japan.”

“. . . ramen of Bookaedo, that is Hokkaido province . . .”

“Hokkaido called Ezochi in the early age . . . ”

“Old name of Hokkaido is “Ezochi [symbol] . . . ”

“Hokkaido called Ezochi . . . ”

“Hokkaido that has been called Ezochi is . . . ”

“Bookaedo (Hokaido (Korean transliteration of Hokkaido)”

“Bookaedo (Hokkaido)”

“Bookaedo -Hokkaido”

“Hokkaido (Bookaedo)”

“Hokaido (Bookaedo)”

“Bookaedo (Hokkaido, [symbol] (Chinese characters of Hokkaido)”

“Hookaedo/Hokkaido”

“Hokkaido [symbol] : Bookaedo)”

“Bookaedo(Hookkaido)”

“Hokkaido [symbol] ”

“Hokkaido [symbol] ”

In this case, there are various synonym recognition patterns such as “A, that is, B is,” “Old name of A is . . . B (“C” and “D”),” “B called as A,” “B that has been called A,” “A (B),” “A-B,” “A (B, C),” “A/B,” “A (B: C),”, and “A [B].” Knowledge is obtained by a method generally used in the field of information extraction. This method is useful to recognize allomorphs different from morphological allomorphs (transliteration occurring in expressing loanwords). The extracted candidates are used to verify the allomorph candidates created by the allomorph candidate creation unit 101.

The allomorph creation unit 103 removes over-created or erroneous candidates using the related word-for-verification extracted from the allomorph candidates and creates allomorphs of the search keyword.

Referring to FIG. 1 again, the allomorph-of-keyword automatic creation apparatus according to the embodiment of the present invention may further include an edit information creation unit 104. The edit information creation unit 104 determines that a first keyword and a second keyword lie in an edit relationship when the first keyword is input in the user session information and the second keyword is input to perform search again without clicking search results of the first keyword.

The term “session” refers to information on a user accessed in same time zone using a single IP. For example, when a user searches for “Allabama” and inputs “Alabama” again for the search without clicking the search results of the keyword “Allabama,” a token “Allabama” and a token “Alabama” are defined to lie in edit relationship.

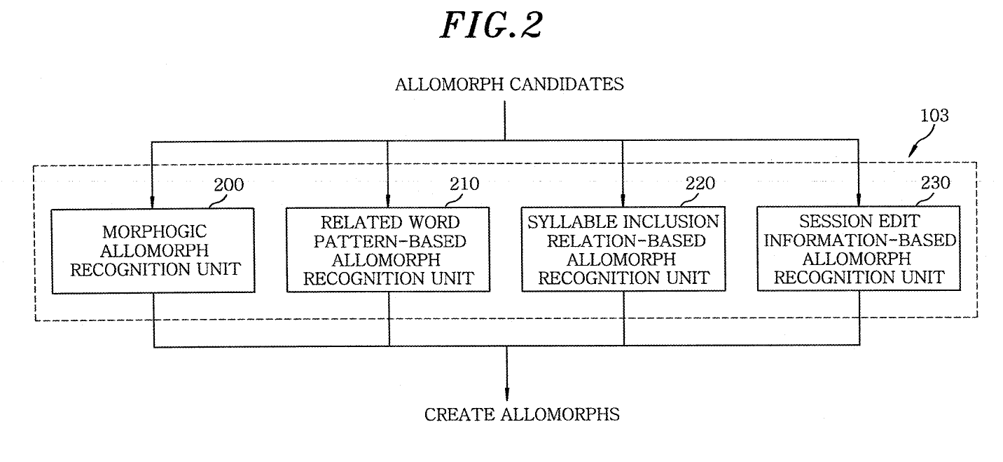

FIG. 2 is a detailed block diagram illustrating an allomorph creation unit of the allomorph-of-keyword automatic creation apparatus.

Referring to FIG. 2, the allomorph creation unit 103 includes a morphologic allomorph recognition unit 200, a related word pattern-based allomorph recognition unit 210, a syllable inclusion relation-based allomorph recognition unit 220, and a session edit information-based allomorph recognition unit 230.

The morphologic allomorph recognition unit 200 selects allomorphs from allomorph candidates using a known method of measuring similarity between vocabularies such as the edit distance. In this case, keywords “Tokyo” and “Ttokyo” become related words. This method may recognize allomorphs generally occurring in transliteration of loanwords.

The related word pattern-based allomorph recognition unit 210, when two tokens included in the allomorph candidates are included in the related words for verification, selects the two tokens as allomorph candidates. The related word pattern-based allomorph recognition unit 210, when the two tokens, included in one allomorph candidate group, are included in verification knowledge based on the allomorph patterns, considers the two tokens as related words. This is because, when another token having the same token as context is verified even by the knowledge extracted based on the related word patterns, another token has a very high possibility of being a related word.

In a case where a short allomorph candidate of two candidates included in the allomorph candidates is divided into several syllables, the syllable inclusion relation-based recognition unit 220 selects the short allomorph candidate as an allomorph when the short allomorph candidate is included in candidates having all long syllables. Keywords “Representatives Association of National College Students” and “RAN” and “Washington Post” and “WP” lie in inclusion relation when being compared with each other by syllable. In a case where a short related word candidate of two candidates included in one group is divided into several syllables, the syllable inclusion relation-based recognition unit 220 considers there is a related word relation between the two candidates when the short candidate is included in related word candidates having all long syllables.

The session edit information-based allomorph recognition unit 230, when there is an edit relation between user session information and tokens of the related word allomorphs, selects the allomorph candidate as an allomorph. The session edit information-based allomorph recognition unit 230, when the fact that there is a related word relation between tokens of a related word group is obtained from search inquiry session information of a user who performs search, considers the fact as a related word relation. At that time, edit information created by the edit information creation unit 104 is utilized.

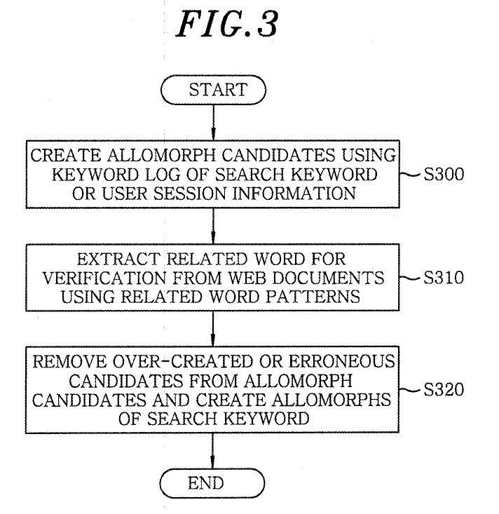

FIG. 3 is a flow chart illustrating the apparatus for automatically keyword allomorphs according to the embodiment of the present invention. Referring to FIGS. 1, 2, and 3, when a user inputs a search keyword, the allomorph candidate creation unit 101 of the keyword allomorph automatic creating apparatus according to the embodiment of the present invention creates allomorph candidates of the search keyword using the user log 110 of the search keyword or the user session information in step S300. In more detail, the allomorph candidate creation unit 101 extracts logs having at least one token from the user log 110 and groups logs sharing at least one token from the extracted logs to create the allomorph candidates in step S300.

After that, the related word-for-verification extraction unit 102 uses the related word patterns to extract related words for verification from the web documents 120 for the verification of the allomorph candidates in step S310.

After the extraction of the related words for verification in step S310, the allomorph creation unit 103 removes over-created or erroneous candidates and creates the allomorphs of the search keyword using the related words for verification extracted from the allomorph candidates in step S320.

The creation of allomorphs may include the following four steps:

First, selecting the allomorphs from the allomorph candidates using a known method of measuring similarity between vocabularies such as an edit distance;

Second, selecting, when two tokens included in the allomorph candidates are included in the related word for verification, the two tokens as allomorphs;

Third, selecting, when a short one of two candidates included in the allomorph candidates is divided into several syllables and the short candidate is included in candidates having all long syllables, the short candidate as the allomorph; and

Fourth, selecting, when there is an edit relation between the user session information and tokens of the allomorph candidate, the allomorph candidate as an allomorph.

Moreover, the method of automatically creating allomorphs of a keyword may further include analyzing the user log from the created allomorphs and selecting a token having the highest frequency as a representative allomorph.

While the invention has been shown and described with respect to the embodiments, it will be understood by those skilled in the art that various changes and modification may be made without departing from the scope of the invention as defined in the following claims.

What is claimed is:

1. A method of automatically creating allomorphs of a keyword, comprising:
creating allomorph candidates of a search keyword using a user log and/or user session information when the search keyword is input;
extracting a related word for verification from a web document using a related word patter from to verify the allomorph candidates; and
removing over-created and/or erroneous candidates from the allomorph candidates using the extracted related word for verification and creating allomorphs of the search keyword.

2. The method of claim 1, wherein, in the creation of the allomorph candidates, the allomorph candidates are created by extracting a log having at least one token from the user log and grouping logs sharing a single token of the extracted logs.

3. The method of claim 1, wherein the creation of the allomorph candidates comprises determining, when a first keyword is input in the user session information and a second keyword is input without clicking a search result of the first keyword, that there is an edit relation between the first keyword and the second keyword.

4. The method of claim 1, wherein the creation of the allomorphs comprises selecting the allomorphs from the allomorph candidates using a known method of measuring similarity between vocabularies such as an edit distance.

5. The method of claim 4, wherein the creation of the allomorphs comprises selecting the allomorph candidates as the allomorphs when two tokens of the allomorph candidates are included in the related word for verification.

6. The method of claim 5, wherein the creation of the allomorphs comprises selecting a short candidate of two allomorph candidates when the short candidate is divided into syllables and includes in candidates having all long syllables.

7. The method of claim 6, wherein the creating allomorphs comprises selecting, when there is an edit relation between the user session information and a token in the allomorph candidate, the allomorph candidate as an allomorph.

8. The method of claim 7, further comprising selecting a token having the highest frequency as an analysis of the user log as a representative allomorph from the created allomorphs after the creation of the allomorphs.

9. An apparatus for automatically creating a keyword allomorphs, comprising:
an allomorph candidate creation unit creating allomorph candidates of a search keyword using a keyword log and/or user session information when the search keyword is input;
a related word-for-verification extracting unit extracting a related word for verification using a related word pattern from a web document for verification of the allomorph candidates; and
an allomorph creation unit remove over-created and/or erroneous candidates from the allomorph candidates using the extracted related word for verification and creating allomorphs of the search keyword.

10. The apparatus of claim 9, wherein the allomorph candidate creation unit creates extracts logs having at least one token from the user log and groups logs sharing at least one log from the extracted logs to create the allomorph candidates.

11. The apparatus of claim 9, further comprising an edit information creation unit determining a first keyword and a second keyword lying in an edit relation when the first keyword is input for search in the user session information and the second keyword is input for search without clicking a search result of the first keyword.

12. The apparatus of claim 9, wherein the allomorph creation unit comprises a morphologic allomorph recognition unit selecting the allomorphs from the allomorph candidates using a known method of measuring similarity between vocabularies such as an edit distance.

13. The apparatus of claim 12, wherein the allomorph creation unit comprises a related word pattern-based allomorph recognition unit selecting the allomorphs when two tokens included in the allomorph candidates are included in the related word for verification.

14. The apparatus of claim 13, wherein the allomorph creation unit comprises a syllable inclusion relation-based allomorph recognition unit selecting, when a short one of two candidates included in the allomorph candidates is divided into syllables and is included in candidates having all long syllables, the short allomorph candidate as the allomorph.

15. The apparatus of claim 14, wherein the allomorph creation unit comprises a session edit information-based allomorph recognition unit selecting, when there is an edit relation between the user session information and the token of the allomorph candidate, the allomorph candidate as an allomorph.
